(19) United States
(12) Patent Application Publication
(10) Pub. No.: US 2024/0317903 A1
(43) Pub. Date: Sep. 26, 2024

(54) PREPARATION OF AMPHIPHILIC BLOCK POLYMERS BY INVERSE MICELLAR RADICAL POLYMERIZATION

(71) Applicant: SPECIALTY OPERATIONS FRANCE, Lyon (FR)

(72) Inventors: David James Wilson, Coye-La-Forêt (FR); Arnaud Cadix, Lille (FR); Hajeeth Thankappan, Dublin 6 (IE)

(73) Assignee: SPECIALTY OPERATIONS FRANCE, Lyon (FR)

(21) Appl. No.: 18/578,651

(22) PCT Filed: Jul. 6, 2022
(86) PCT No.: PCT/EP2022/068709

§ 371 Date: Jan. 11, 2024

(30) Foreign Application Priority Data
Jul. 13, 2021 (FR) 2107584

(51) Int. Cl. C08F 2/08; C08F 2/38; C08F 220/18; C08F 293/00

(52) U.S. Cl. CPC C08F 2/08; C08F 2/38; C08F 220/1812; C08F 293/005; C08F 2400/02; C08F 2438/03

(57) ABSTRACT

The present invention relates to the preparation of block copolymers which are particularly useful as a rheology agent, and which are suitable, inter alia, for oil extraction, which comprises a step of radical polymerization in which the following are brought into contact, in an oily medium:
monomers dissolved in the oily medium;
monomers which are insoluble in the oily medium, in the form of a micellar solution;
at least one radical polymerization initiator; and
preferably at least one radical polymerization control agent.

The invention also relates to the polymers obtained by this process and the use thereof as surfactants or dispersants.

The present invention relates to a polymerization process that gives access to amphiphilic agents which are dispersible in an oily medium and which are particularly of use as stabilizers for inverse emulsions (emulsions of the water-in-oil type, comprising globules of aqueous phase dispersed in an oily phase).

In order to stabilize inverse emulsions, it is known to use compounds of a surfactant nature, which are typically soluble in the oily phase and are able to lower the surface tension between the dispersed aqueous phase and the oily phase. In particular, the use of block polymers comprising hydrophobic blocks and hydrophilic blocks has been described, among which mention may for example be made of Rhodibloc® RS available from Solvay.

One aim of the present invention is to provide novel amphiphilic agents which are particularly suited to use in the oily phase and which enable, inter alia, good stabilization of inverse emulsions.

To this end, according to the invention, a particular polymerization process is proposed which gives access to amphiphilic block polymers that have a specific controlled structure, namely, broadly speaking, based on a backbone formed from lipophilic units interrupted at various places with small hydrophilic blocks, these hydrophilic blocks all being of substantially identical size.

To achieve this, in the context of the present invention, the studies that were performed by the inventors have now made it possible to develop a beneficial variant of the technique known as “micellar radical polymerization”.

“Micellar radical polymerization” (also referred to here more concisely as “micellar polymerization”) is described for example in U.S. Pat. No. 4,432,881 or else in Polymer, vol. 36, no. 16, pp. 3197-3211 (1996). This particular polymerization technique makes it possible to synthesize multiblock-type block polymers by copolymerization of hydrophilic monomers and hydrophobic monomers within an aqueous dispersant medium (typically water or a water/alcohol mixture) which comprises:
hydrophilic monomers in dissolved form or dispersed form in said medium; and
hydrophobic monomers in surfactant micelles formed in said medium by introducing this surfactant therein at a concentration above its critical micelle concentration (cmc).

In micellar polymerization, the hydrophobic monomers contained in the micelles are said to be in “micellar solution”. The micellar solution to which reference is made here is a microheterogeneous system which is generally isotropic, optically transparent and thermodynamically stable.

It should be noted that a micellar solution of the type employed in micellar polymerization should be distinguished from a microemulsion. In particular, unlike a microemulsion, a micellar solution is formed at any concentration exceeding the critical micelle concentration of the surfactant employed, with the sole condition that the hydrophobic monomer be soluble at least to a certain extent within the internal space of the micelles. A micellar solution furthermore differs from an emulsion by the absence of a homogeneous internal phase: the micelles contain a very small number of molecules (typically less than 1000, generally less than 500 and typically from 1 to 100, usually with 1 to 50, monomers, and at most a few hundred surfactant molecules, when a surfactant is present) and the micellar solution generally has physical properties similar to those of the monomer-free surfactant micelles. Furthermore a micellar solution is usually transparent with regard to visible light, in view of the small size of the micelles which does not result in scattering phenomena, unlike the drops of an emulsion, which refract light and give it its characteristic cloudy or white appearance.

The micellar polymerization technique using aqueous micellar solutions of this type results in characteristic block polymers which each contain several hydrophobic blocks of substantially the same size and in which this size can be controlled. This is because, in view of the confinement of the hydrophobic monomers within the micelles, each of the hydrophobic blocks formed is of controlled size and contains substantially a defined number n_{H} of hydrophobic monomers, it being possible for this number n_{H} to be calculated as follows (Macromolecular Chem. Physics, 202, 8, 1384-1397, 2001):

$${n}_{H} = {N}_{agg} . [ {M}_{H} ] / ( [ surfactant ] - cmc )$$

where:
N_{agg} is the aggregation number of the surfactant, which reflects the number of surfactants present in each micelle
[M_{H}] is the molar concentration of hydrophobic monomer in the medium [surfactant] is the molar concentration of surfactant in the medium; and
cmc is the critical micelle (molar) concentration.

The micellar polymerization technique thus enables advantageous control of the hydrophobic units introduced into the polymers formed, namely:
overall control of the molar fraction of hydrophobic units in the polymer (by adjusting the ratio of the concentrations of the two monomers); and
more specific control of the number of hydrophobic units present in each of the hydrophobic blocks (by modifying the parameters influencing the n_{H}, defined above).

The inventors have now developed a process that employs some of the principles of micellar polymerization but in which the dispersant medium used is no longer water or an aqueous phase but rather an oily hydrophobic phase. Quite unexpectedly, transposing the process into a hydrophobic medium has proven possible as long as technical adaptations are provided by the inventors. Even more surprisingly, the novel variant developed by the inventors makes it possible to obtain highly advantageous polymers which prove particularly well suited to modifying the properties of an oily phase and particularly to stabilize inverse emulsions and more generally to stabilize the dispersion of hydrophilic particles or globules in an oil.

To this end, according to a first aspect, one subject of the present invention is a process for preparing a block copolymer, which comprises a step (E) of radical polymerization, referred to here as “inverse micellar polymerization” in which the following are brought into contact, in an oily medium (M):
monomers m1 dissolved in said oily medium (M);
monomers m2, which are insoluble in the medium (M) and which are present in the form of a micellar solution, i.e. contained in micelles dispersed in the medium (M);
at least one radical polymerization initiator, this initiator typically being soluble or dispersible in the medium (M); and
optionally (and preferably) at least one radical polymerization control agent.

According to another aspect, a subject of the invention is the polymers obtained according to the processes comprising a step (E) of the aforementioned type.

Step (E) of the process of the invention therefore specifically uses a medium (M) of oil type, with monomers m1 dissolved therein (this means that the monomers m1 can be dissolved in the medium (M) and that they are present therein in the form of a homogeneous dispersion or solution) and monomers m2 which are present therein in the form of a micellar solution. The micellar solution of monomers m2 is not an emulsion: it does not comprise an aqueous phase dispersed in the medium (M) but rather only micelles which comprise the monomers m2. Thus, the medium (M) comprising the monomers m1 and m2 under the conditions of the invention is generally isotropic, optically transparent and thermodynamically stable.

Typically, the monomers m2 are present in the medium (M) in micelles formed by additional surfactants, introduced in addition to monomers m1 and m2 (with these micelles being readily obtained by employing the surfactant at a concentration above its critical micelle concentration). These surfactants form micelles with an internal space, typically hydrophilic in nature, in which the monomers m2 are soluble. The micellar solution obtained is thus in the form of micelles containing a small number of molecules, and the micellar solution generally has similar physical properties to those of surfactant micelles without monomers.

Alternatively, according to a more specific embodiment, the monomers m2 used in micellar solution may be monomers which inherently have the property of forming micelles without needing to add additional surfactants thereto (monomers m2 referred to here as “self-micellizable”). According to this very specific embodiment, the surfactant employed to form the micelles may be the self-micellizable monomer itself, employed without other surfactant, although the presence of an additional surfactant is not excluded.

Thus, for the purposes of the present description, when mention is made monomers m2 in surfactant micelles, this concept encompasses both (i) hydrophilic monomers present in surfactant micelles other than these monomers, and (ii) monomers comprising at least one hydrophilic part or block and forming by themselves the micelles in oily medium. The two abovementioned embodiments (i) and (ii) are compatible and may coexist (hydrophilic monomers in micelles formed by another self-micellizable monomer for example, or else micelles comprising a combination of surfactants and self-micellizable monomers).

Step (E) of inverse micellar polymerization according to the invention leads to multiblock polymers that bear the hallmark of using monomers m2 in the form of a micellar solution: step (E) is, broadly speaking, a radical polymerization in solution of monomers m1 (which, in the absence of micelles, would lead to polymer chains consisting of a sequence of units m1), but the presence of micelles in some way disrupts the growth of the chains, as a result of which a backbone is obtained which is formed by the polymerization of the monomers m1 interrupted at various places with small hydrophilic blocks, each of these blocks being formed by the polymerization of monomers m2 contained in a micelle encountered by the growing chain. Because each of the micelles of the micellar solution comprises substantially the same amount of monomers m2, all the hydrophilic blocks interrupting the hydrophobic chain are all of substantially identical size. Thus, a polymer chain obtained according to step (E) has, broadly speaking, the structure of a “pearl necklace” with small hydrophilic blocks of uniform size distributed along a hydrophobic chain. One of the advantages of the process of the invention is that the size of the hydrophilic blocks can be readily modified simply by adjusting the number of monomers m2 present in each micelle (in the event that additional surfactants are introduced to form micelles, for example, it is typically possible to adjust the monomer m2/surfactant molar ratio: the lower this ratio, the fewer monomers m2 contained in the micelles).

It is generally preferred to carry out step (E) with the additional presence of a radical polymerization control agent as described in greater detail below, without which the inverse micellar polymerization of step (E) still leads to fine control of the size of the small hydrophobic blocks, but to more erratic polymerization of the hydrophilic monomer units, which ultimately leads to chains having the aforementioned pearl necklace structure but with a nonuniformity of the length of the hydrophobic backbones, and thus to a highly polydispersed molecular weight distribution for the chains obtained. The use of a radical polymerization control agent makes it possible to obtain more monodispersed distributions and also better control of the microstructure of the polymers obtained (namely the distribution of the hydrophobic blocks within the different chains), which permits, as needed, fine control of the properties of the polymer chains obtained.

Surprisingly, the inventors' studies have now demonstrated that inverse micellar polymerization performed in the presence of a control agent makes it possible to retain both the advantages associated with the presence of a micellar solution (block polymers comprising hydrophilic blocks of controlled size) and the advantages of controlled radical polymerization (improved control of the average molecular weight of the chains synthesized and control of the microstructure of the polymers, particularly with uniformity, from one chain to another, in the distribution of the hydrophilic blocks within the backbone).

The polymers as obtained according to the present invention may be used in many fields. They may most particularly be used as surfactants in an oily medium and particularly as stabilizers for a water-in-oil emulsion, or else as dispersants for hydrophilic particles dispersed in an oil.

More generally, they may be used for modifying an oily medium or an interface between an oily medium and another medium, particularly for forming and/or stabilizing an inverse emulsion or another dispersed system, comprising:
droplets of water or of a hydrophilic liquid dispersed in an oily medium; or
hydrophilic particles dispersed in an oily medium.

According to a third aspect, one subject of the invention is this particular use of the polymers obtained according to the invention. Another subject of the invention is the processes for modifying oily media using these polymers as surfactants. The invention also relates to emulsions of water-in-oil type and also to dispersions of hydrophilic particles in oily media comprising at least one polymer according to the invention (typically as stabilizers and/or dispersants).

Various features and embodiments of the invention are described in greater detail below.

### The Medium M Employed in Step (E)

The medium (M) used in the step of inverse micellar polymerization of the invention is typically a homogeneous medium. This medium usually comprises one or more hydrophobic compounds forming a more or less viscous liquid phase.

The nature of the medium M may vary to quite a large extent, as long as it enables dissolution (or at least good dispersion) of the monomers m1 and as long as it is able to form the micelles sought in step (E). By way of example of a medium (M) suitable for carrying out the process of the invention, mention may particularly be made of cyclohexane or else liquid paraffins such as Exxsol D100.

### The Radical Polymerization Control Agent

For the purposes of the present description, the term “radical polymerization control agent” means a compound which is capable of extending the lifetime of the growing polymer chains in a polymerization reaction and of giving the polymerization a living or controlled nature. This control agent is typically a reversible transfer agent as used in controlled radical polymerizations denoted by the terminology RAFT or MADIX, which typically use a reversible addition-fragmentation transfer process, such as those described, for example, in WO96/30421, WO 98/01478, WO 99/35178, WO 98/58974, WO 00/75207, WO 01/42312, WO 99/35177, WO 99/31144, FR2794464 or WO 02/26836.

According to an advantageous embodiment, the radical polymerization control agent employed in step (E) is a compound which comprises a thiocarbonylthio group —S(C═S)—. Thus, for example, it may be a compound which comprises a xanthate group (bearing —SC═S—O— functions), for example a xanthate. According to a particular embodiment, the control agent may bear a plurality of thiocarbonylthio groups. It may optionally be a polymer chain bearing such a group. Other types of control agent may be envisaged (for example of the type employed in CRP or in ATRP).

A control agent well suited to carrying out step (E) corresponds to formula (A) below:

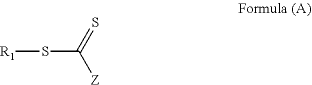

in which:
   Z represents:
      a hydrogen atom,
      a chlorine atom,
      an optionally substituted alkyl or optionally substituted aryl radical,
      an optionally substituted heterocycle,
      an optionally substituted alkylthio radical,
      an optionally substituted arylthio radical,
      an optionally substituted alkoxy radical,
      an optionally substituted aryloxy radical,
      an optionally substituted amino radical,
      an optionally substituted hydrazinyl radical,
      an optionally substituted alkoxycarbonyl radical,
      an optionally substituted aryloxycarbonyl radical,
      an optionally substituted acyloxy or carboxyl radical,
      an optionally substituted aroyloxy radical,
      an optionally substituted carbamoyl radical,
      a cyano radical,
      a dialkyl- or diarylphosphonato radical,
      a dialkylphosphinato or diarylphosphinato radical, or
      a polymer chain,
and
   R1 represents:
      an optionally substituted alkyl, acyl, aryl, aralkyl, alkene or alkyne group,
      a saturated or unsaturated, aromatic, optionally substituted, carbocycle or heterocycle, or
      a polymer chain, which is preferably hydrophilic or water-dispersible when the agent is used in step (E).

The groups R₁ or Z, when they are substituted, may be substituted with optionally substituted phenyl groups, optionally substituted aromatic groups, saturated or unsaturated carbocycles, saturated or unsaturated heterocycles, or groups selected from the following: alkoxycarbonyl or aryloxycarbonyl (—COOR), carboxyl (—COOH), acyloxy (—O₂CR), carbamoyl (—CONR₂), cyano (—CN), alkylcarbonyl, alkylarylcarbonyl, arylcarbonyl, arylalkylcarbonyl, phthalimido, maleimido, succinimido, amidino, guanidino, hydroxyl (—OH), amino (—NR₂), halogen, perfluoroalkyl CₙF₂ₙ₊₁, allyl, epoxy, alkoxy (—OR), S-alkyl, S-aryl, groups having hydrophilic or ionic nature, such as alkali metal salts of carboxylic acids, alkali metal salts of sulfonic acid, polyalkylene oxide (PEO, PPO) chains, cationic substituents (quaternary ammonium salts), R representing an alkyl or aryl group, or a polymer chain.

The optionally substituted alkyl, acyl, aryl, aralkyl or alkyne groups generally have 1 to 20 carbon atoms, preferably 1 to 12 and more preferentially 1 to 9 carbon atoms. They may be linear or branched. They may also be substituted with oxygen atoms, particularly in the form of esters, sulfur atoms or nitrogen atoms.

Mention may in particular be made, among the alkyl radicals, of the methyl, ethyl, propyl, butyl, pentyl, isopropyl, tert-butyl, hexyl, octyl, decyl or dodecyl radical.

The alkyne groups are radicals generally of 2 to 10 carbon atoms, having at least one acetylenic unsaturation, such as the acetylenyl radical.

The acyl group is a radical generally having from 1 to 20 carbon atoms with a carbonyl group.

Mention may in particular be made, among the aryl radicals, of the phenyl radical, which is optionally substituted, in particular with a nitro or hydroxyl function.

Mention may in particular be made, among the aralkyl radicals, of the benzyl or phenethyl radical, which is optionally substituted, in particular with a nitro or hydroxyl function.

When R₁ or Z is a polymer chain, this polymer chain may result from a radical or ionic polymerization or result from a polycondensation.

According to a particular embodiment, the control agent employed in step (E) is a non-polymeric compound bearing a group which ensures control of the radical polymerization, in particular a thiocarbonylthio —S(C═S)— group.

According to another embodiment which may be envisaged, the control agent employed in step (E) may optionally be a polymer chain resulting from a controlled radical polymerization and bearing a group that is capable of controlling a radical polymerization (polymer chain of “living” type, which is a type that is well known per se). Thus, for example, the control agent may be a polymer chain (preferably hydrophobic) functionalized at the chain end with a xanthate group or more generally comprising an —SC═S— group, for example obtained according to the MADIX technology.

Advantageously, compounds bearing a xanthate —S(C═S)O—, trithiocarbonate, dithiocarbamate or dithiocarbazate function, for example bearing an O-ethyl xanthate function of formula —S(C═S)OCH₂CH₃, may be used as control agent for step (E).

Xanthates prove to be most particularly advantageous, particularly those bearing an O-ethyl xanthate-S(C═S)OCH₂CH₃ function, such as O-ethyl S-(1-(methoxycarbonyl)ethyl) xanthate (CH₃CH(CO₂CH₃))S(C═S)OEt. Another possible control agent is dibenzyl trithiocarbonate of formula PhCH₂S(C═S)SCH₂Ph (where Ph=phenyl). An advantageous control agent is Rhodixan A1 available from Solvay.

The studies carried out by the inventors in the context of the present invention have now made it possible to demonstrate that, when step (E) is performed in the presence of such a radical polymerization control agent, it generally leads to:
control of the average molecular weight of the polymer chains formed;
control of the distribution of the hydrophilic blocks within the various chains;
production of polymer chains having a living nature, thereby offering the possibility of preparing complex polymers with controlled architecture.

Quite unexpectedly, step (E) makes it possible to preserve the general advantages of controlled radical polymerization despite the presence of micelles in the polymerization medium, where it would have been expected that they might adversely affect the control agents. Thus, by employing a radical polymerization control agent, it is readily possible to perform controlled polymerization of the monomers present in the medium M in a similar manner to a controlled radical polymerization performed in homogeneous medium, thus making it possible to very easily predict and control the average molar mass of the synthesized polymer (this mass is proportionately higher the lower the initial concentration of control agent in the medium, since this concentration dictates the number of growing polymer chains). At the same time, the presence of control agent is not detrimental to the advantageous effect observed due to the presence of the monomers m2 in micellar solution, namely the precise control of the size of the hydrophilic blocks.

Under the conditions of step (E), it proves possible to control the number-average molar mass of the polymers to values ranging typically up to 300 000 g/mol, for example between 5000 and 200 000 g/mol, for example between 1000 and 150 000 g/l.

Regardless of the size of the polymers synthesized in step (E), these polymers have a highly controlled microstructure when a control agent is employed, with chains which are substantially all similar, comprising hydrophobic blocks distributed substantially in the same way from one polymer chain to another. This homogeneity in the distribution of the hydrophobic blocks from one chain to another makes it possible to obtain a polymer population all having similar properties, which makes it possible to provide compositions having perfectly targeted and reproducible properties. The polymers obtained according to the invention differ in that respect from the polymers generally obtained in micellar polymerization, which usually have a very broad and very heterogeneous dispersion of the distribution of the hydrophilic blocks within the various chains.

When a polymerization control agent, in particular of the abovementioned type, is employed, polymers functionalized by transfer groups (living polymers) are typically obtained at the end of step (E). This living nature makes it possible, if desired, to employ these polymers as control agent in a subsequent radical polymerization reaction according to a technique that is well known per se, which enables the polymer chain obtained in step (E) to be extended. Alternatively, if required, it is possible to deactivate or to destroy the transfer groups, for example by hydrolysis, ozonolysis or reaction with amines, according to means known per se, by means of which the chains lose their living nature.

Thus, according to a particular embodiment, the process of the invention may comprise, after step (E), a step (E1) of hydrolysis, of oxidation, of ozonolysis or of reaction with amines which is capable of deactivating and/or destroying all or some of the transfer groups present on the polymer prepared in step (E).

### Monomers m1

According to the invention, use may be made as monomers m1 of monomers which: (i) are soluble in the medium (M); and (2) lead to the formation of polymers which remain soluble in the medium (M).

These monomers are typically lipophilic and hydrophobic.

Mention may particularly be made, as monomers m1 which are particularly well suited, particularly when the medium M is cyclohexane or a liquid paraffin, of: tert-butyl acrylate, isobornyl (meth)acrylate, 2-ethylhexyl acrylate, lauryl acrylate (LA), lauryl methacrylate (LMA), stearyl acrylate (SA), stearyl methacrylate (SMA), behenyl (meth)acrylate, oleyl (meth)acrylate and mixtures thereof.

More broadly, use may be made, as monomers m1, of other hydrophobic monomers, particularly including:
vinylaromatic monomers, such as styrene, α-methylstyrene, para-chloromethylstyrene, vinyltoluene, 2-methylstyrene, 4-methylstyrene, 2-(n-butyl)styrene or 4-(n-decyl)styrene;
halogenated vinyl compounds, such as vinyl or vinylidene halides, for example vinyl or vinylidene chlorides or fluorides, corresponding to the formula R_{b}R_{c}C═CX¹X², in which:
   X¹═F or Cl
   X²═H, F or Cl
   each of R_{b} and R_{c} represents, independently:
      H, Cl, F; or
      an alkyl group, preferably chlorinated and/or fluorinated, more advantageously perchlorinated or perfluorinated;
esters of α,β-ethylenically unsaturated monocarboxylic or dicarboxylic acids with C₂-C₃₀ alkanols, for example methyl ethacrylate, ethyl (meth)acrylate, ethyl ethacrylate, n-propyl (meth)acrylate, isopropyl (meth)acrylate, n-butyl (meth)acrylate, sec-butyl (meth)acrylate, tert-butyl (meth)acrylate, tert-butyl ethacrylate, n-hexyl (meth)acrylate, n-heptyl (meth)acrylate, n-octyl (meth)acrylate, 1,1,3,3-tetramethylbutyl (meth)acrylate, ethylhexyl (meth)acrylate, n-nonyl (meth)acrylate, n-decyl (meth)acrylate, n-undecyl (meth)acrylate, tridecyl (meth)acrylate, myristyl (meth)acrylate, pentadecyl (meth)acrylate, palmityl (meth)acrylate, heptadecyl (meth)acrylate, nonadecyl (meth)acrylate, arachinyl (meth)acrylate, behenyl (meth)acrylate, lignoceryl (meth)acrylate, cerotinyl (meth)acrylate, melissinyl (meth)acrylate, palmitoleoyl (meth)acrylate, oleyl (meth)acrylate, linolyl (meth)acrylate, linolenyl (meth)acrylate, stearyl (meth)acrylate, lauryl (meth)acrylate, and mixtures thereof;
esters of vinyl or allyl alcohol with C1-C30 monocarboxylic acids, for example vinyl formate, vinyl acetate, vinyl propionate, vinyl butyrate, vinyl laurate, vinyl stearate, vinyl propionate, vinyl versatate and mixtures thereof;
ethylenically unsaturated nitriles, such as acrylonitrile, methacrylonitrile, and mixtures thereof;
primary amides of α,β-ethylenically unsaturated monocarboxylic and dicarboxylic acids and N-alkyl and N,N-dialkyl derivatives, such as N-(n-octyl)(meth)acrylamide, N-(1,1,3,3-tetramethylbutyl)(meth)acrylamide, N-ethylhexyl(meth)acrylamide, N-(n-nonyl)(meth)acrylamide, N-(n-decyl)(meth)acrylamide, N-(n-undecyl)(meth)acrylamide, N-tridecyl(meth)acrylamide, N-myristyl(meth)acrylamide, N-pentadecyl(meth)acrylamide, N-palmityl(meth)acrylamide, N-heptadecyl(meth)acrylamide, N-nonadecyl(meth)acrylamide, N-arachinyl(meth)acrylamide, N-behenyl(meth)acrylamide, N-lignoceryl(meth)acrylamide, N-cerotinyl(meth)acrylamide, N-melissinyl(meth)acrylamide, N-palmitoleoyl(meth)acrylamide, N-oleyl(meth)acrylamide, N-linolyl(meth)acrylamide, N-linolenyl(meth)acrylamide, N-stearyl(meth)acrylamide and N-lauryl(meth)acrylamide;
N-vinyllactams and derivatives thereof, such as N-vinyl-5-ethyl-2-pyrrolidone, N-vinyl-6-methyl-2-piperidone, N-vinyl-6-ethyl-2-piperidone, N-vinyl-7-methyl-2-caprolactam, N-vinyl caprolactam and N-vinyl-7-ethyl-2-caprolactam;
esters of α,β-ethylenically unsaturated monocarboxylic and dicarboxylic acids with amino alcohols, for example N,N-dimethylaminocyclohexyl (meth)acrylate;

C2-C8 monoolefins and nonaromatic hydrocarbons comprising at least one double bond, for example ethylene, propylene, isobutylene, isoprene or butadiene.

According to a preferential embodiment, the hydrophobic monomers employed according to the invention can be chosen from:
C2-C30 alkyl and preferably C₄-C₂₂ α,β-unsaturated esters, in particular alkyl acrylates and methacrylates, such as butyl, 2-ethylhexyl, isooctyl, lauryl, isodecyl or stearyl acrylates and methacrylates (lauryl methacrylate in particular proves to be advantageous);
mixtures and combinations of two or more of the abovementioned monomers.

Preferably, in step (E), all the monomers m1 employed are dissolved in the oily medium (M).

### Monomers m2

These are monomers distinct from the monomers m1 and which, unlike the monomers m1, are insoluble per se in the medium (M). They are used in step (E) in the form of a micellar solution, i.e. in a dispersed form within micelles which are dispersed in the medium (M). Provided that they can be incorporated into micelles of this type, any monomer of hydrophilic nature may be envisaged in step (E).

By way of nonlimiting example of monomers m2 which are well suited to carrying out the inverse micellar polymerization of step (E), mention may particularly be made of acrylic acid (AA); hydroxyethyl methacrylate (HEMA); N,N-dimethylacrylamide (DMA), and mixtures thereof.

Other monomers suitable as monomers m2 include, inter alia:
ethylenically unsaturated carboxylic acids, sulfonic acids and phosphonic acids, and/or derivatives thereof such as acrylic acid (AA), methacrylic acid, ethacrylic acid, α-chloroacrylic acid, crotonic acid, maleic acid, maleic anhydride, itaconic acid, citraconic acid, mesaconic acid, glutaconic acid, aconitic acid, fumaric acid, monoethylenically unsaturated dicarboxylic acid monoesters comprising 1 to 3 and preferably 1 to 2 carbon atoms, for example monomethyl maleate, vinylsulfonic acid, (meth)allylsulfonic acid, sulfoethyl acrylate, sulfoethyl methacrylate, sulfopropyl acrylate, sulfopropyl methacrylate, 2-hydroxy-3-acryloyloxypropylsulfonic acid, 2-hydroxy-3-methacryloyloxypropylsulfonic acid, styrenesulfonic acids, 2-acrylamido-2-methylpropanesulfonic acid, vinylphosphonic acid, α-methylvinylphosphonic acid and allylphosphonic acid;
esters of α,β-ethylenically unsaturated monocarboxylic and dicarboxylic acids with C2-C3 alkanediols, for example 2-hydroxyethyl acrylate, 2-hydroxyethyl methacrylate, 2-hydroxyethyl ethacrylate, 2-hydroxypropyl acrylate, 2-hydroxypropyl methacrylate, 3-hydroxypropyl 3-hydroxypropyl methacrylate and polyalkylene glycol (meth)acrylates;
α,β-ethylenically unsaturated monocarboxylic acid amides and the N-alkyl and N,N-dialkyl derivatives thereof, such as acrylamide, methacrylamide, N-methyl(meth)acrylamide, N-ethyl(meth)acrylamide, N-propyl(meth)acrylamide, N,N-dimethyl(meth)acrylamide, N,N-diethyl(meth)acrylamide, morpholinyl(meth)acrylamide, and metholylacrylamide (acrylamide and N,N-dimethyl(meth)acrylamide prove to be particularly advantageous);
N-vinyllactams and derivatives thereof, for example N-vinylpyrrolidone and N-vinylpiperidone;
N-vinylamide compounds having open chains, for example N-vinylformamide, N-vinyl-N-methylformamide, N-vinylacetamide, N-vinyl-N-methylacetamide, N-vinyl-N-ethylacetamide, N-vinylpropionamide, N-vinyl-N-methylpropionamide and N-vinylbutyramide;
esters of α,β-ethylenically unsaturated monocarboxylic and dicarboxylic acids with amino alcohols, for example N,N-dimethylaminomethyl (meth)acrylate, N,N-dimethylaminoethyl (meth)acrylate, N,N-diethylaminoethyl acrylate, and N,N-dimethylaminopropyl (meth)acrylate;
amides of α,β-ethylenically unsaturated monocarboxylic and dicarboxylic acids with diamines comprising at least one primary or secondary amino group, such as N-[2-(dimethylamino)ethyl]acrylamide, N[2-(dimethylamino)ethyl]methacrylamide, N-[3-(dimethylamino)propyl]acrylamide, N-[3-(dimethylamino)propyl]methacrylamide, N-[4-(dimethylamino)butyl]acrylamide and N-[4-(dimethylamino)butyl]methacrylamide;
N-diallylamines, N,N-diallyl-N-alkylamines, acid-addition salts thereof and quaternization products thereof, the alkyl used here preferentially being C1-C3-alkyl;
N,N-diallyl-N-methylamine and N,N-diallyl-N,N-dimethylammonium compounds, for example the chlorides and bromides;
nitrogenous heterocycles substituted with vinyl and allyl, for example N-vinylimidazole, N-vinyl-2-methylimidazole, heteroaromatic compounds substituted with vinyl and allyl, for example 2- and 4-vinylpyridine, 2- and 4-allylpyridine, and salts thereof;
sulfobetaines; and
mixtures and combinations of two or more of the abovementioned monomers.

For the purposes of the present description, the term “(meth)acrylic acid” includes methacrylic acid, acrylic acid, and mixtures thereof.

Similarly, for the purposes of the present description, the term “(meth)acrylate” includes methacrylate, acrylate, and mixtures thereof.

Similarly, for the purposes of the present description, the term “(meth)acrylamide/(meth)acrylamido” includes methacrylamide/methacrylamido, acrylamide/acrylamido, and mixtures thereof.

Preferably, the micelles of the micellar solution of step (E) do not contain monomers having a hydrophobic nature. Moreover, preferably, all the hydrophobic monomers employed in step (E) are contained in micelles of the micellar solution.

### The Micellar Solution

In order to produce the micellar solution containing the monomers m2 employed in step (E), use is typically made of surfactants which are at least dispersible, and advantageously soluble, in the medium (M), and which are generally present in said medium at a concentration above their critical micelle concentration. These surfactants are typically surfactants having a low HLB, typically of less than 9, for example of less than or equal to 7.

It is also preferred in step (E) to employ surfactants which, in the isolated state, are in liquid rather than solid form under the temperature conditions of step (E), particularly in order to facilitate the metering-in of said surfactants and their dissolution in the medium (M) which makes it possible to obtain micelles.

Moreover, the surfactants employed to form the micelles of the micellar solution are surfactants capable of dissolving the monomers m2. In order for the surfactant micelles to themselves be capable of dissolving the monomers m2, it is generally preferable for the weight ratio of the total weight of surfactants present in the medium (M) of step (E) to the weight of monomers m2 initially present in the medium (M) of step (E) to be at least equal to 0.6:1, for example greater than or equal to 0.7:1; more advantageously greater than or equal to 0.8:1 and particularly greater than or equal to 0.9:1. According to a typical embodiment, this ratio is greater than or equal to 1:1. This weight ratio typically remains less than or equal to 5:1. Thus, the weight ratio of the total weight of surfactants present in the medium (M) of step (E) to the weight of monomers m2 initially present in the medium (M) of step (E) is advantageously between 0.6:1 and 5:1, for example between 0.7:1 and 4:1

By way of nonlimiting example, in order to form the micelles of the micellar solution of step (E), surfactants chosen from fatty acid sorbitan esters, for example sorbitan monooleate, referred to as SMO, or else sorbitan monostearate, and sulfosuccinates such as bis(2-ethylhexyl)sulfosuccinate sodium salt (referred to as “AOT”), may be employed. Commercial surfactants such as SPAN® 80 may for example be employed.

These surfactants are advantageously used in a mixture with an alkanolamide.

### Initiating the Radical Polymerization of Step (E)

The radical polymerization initiator used in step (E) is preferably soluble or dispersible in the oily medium (M).

The radical polymerization initiator employed according to the invention may particularly be chosen from the following initiators:
redox pairs that are soluble in an oily medium, for instance the lauryl peroxide/N,N-trimethylaniline pair;
initiators treated to be soluble in oily medium, for example of the 2,2′-azobis(2,4-dimethylvaleronitrile) type;
hydrogen peroxides, such as: tert-butyl hydroperoxide, cumene hydroperoxide, t-butyl peroxyacetate, t-butyl peroxybenzoate, t-butyl peroxyoctoate, t-butyl peroxyneodecanoate, t-butyl peroxyisobutyrate, lauroyl peroxide, t-amyl peroxypivalate, t-butyl peroxypivalate, dicumyl peroxide, benzoyl peroxide, potassium persulfate or ammonium persulfate,
azo compounds, such as: 2,2′-azobis(isobutyronitrile), 2,2′-azobis(2-butanenitrile), 4,4′-azobis(4-pentanoic acid), 1,1′-azobis(cyclohexanecarbonitrile), 2-(t-butylazo)-2-cyanopropane, 2,2′-azobis[2-methyl-N-(1,1)-bis(hydroxymethyl)-2-hydroxyethyl]propionamide, 2,2′-azobis(2-methyl-N-hydroxyethyl]propionamide, 2,2′-azobis(N,N′-dimethyleneisobutyramidine) dichloride, 2,2′-azobis(2-amidinopropane) dichloride, 2,2′-azobis(N,N′-dimethyleneisobutyramide), 2,2′-azobis(2-methyl-N-[1,1-2,2′-azobis(2-methyl-N-[1,1-bis(hydroxymethyl)-2-hydroxyethyl]propionamide), bis(hydroxymethyl)ethyl]propionamide), 2,2′-azobis[2-methyl-N-(2-hydroxyethyl)propionamide], 2,2′-azobis(isobutyramide) dihydrate,
redox systems comprising combinations, such as:
   mixtures of hydrogen peroxide, alkyl peroxide, peresters, percarbonates and the like and of any of the iron salts, titanous salts, zinc formaldehyde sulfoxylate or sodium formaldehyde sulfoxylate, and reducing sugars,
   alkali metal or ammonium persulfates, perborates or perchlorates in combination with an alkali metal bisulfite, such as sodium metabisulfite, and reducing sugars, and
   alkali metal persulfates in combination with an arylphosphinic acid, such as benzenephosphonic acid and the like, and reducing sugars.

Typically, when a polymerization control agent is employed, the amount of initiator to be used is preferably such that the amount of radicals generated is at most 50 mol % and preferably at most 20 mol %, relative to the amount of control agent.

### Use of the Polymers of the Invention

The polymers obtained at the end of step (E) and of the optional step (E1) of activating/eliminating transfer groups present on the polymer prepared in step (E) are, inter alia, of use as a modifier of an oily medium or of an interface between an oily medium and another medium, particularly a hydrophilic liquid medium. They prove particularly advantageous for decreasing the surface tension at oil-water type interfaces, and they are most particularly suited for stabilizing inverse emulsions (or more generally systems comprising droplets of water (or aqueous medium) dispersed in an oily medium). More specifically, the polymers according to the invention prove particularly advantageous as additives in inverse emulsions including surfactants (for instance SMO) for improving the long-term stability of inverse emulsions.

Moreover, the nature of the polymers that can be synthesized according to the present invention is extremely modulable, which permits a very wide choice both regarding the backbone and regarding the presence of substituents, which may be judiciously modulated depending on the envisaged uses of the polymer.

Various aspects and advantages of the invention will be further illustrated by the examples below, in which polymers were prepared according to the process of the invention.

### EXAMPLES

### Example 1

### Preparation of a Polymer P1 of Poly(LA-Co-AA) Type by Inverse Micellar Radical Polymerization

### Preparation of a Micellar Solution S1

10 ml of Exxsol, 1 g of acrylic acid and 4 g of surfactant Mackamide WS1 were introduced into a glass flask. The mixture was stirred using a magnetic stirrer bar for 30 minutes, until a visually clear mixture was obtained.

### Inverse Micellar Polymerization

18.10 g of lauryl acrylate and 25.45 g of Exxsol D100 were introduced into a round-bottomed flask containing a magnetic stirrer. The solution obtained was purged under nitrogen for 30 minutes, after which 0.064 g of Rhodixan A1, 7.6 g of the previously prepared micellar solution S1, and 0.082 g of 2,2′-azobis(2,4-dimethylvaleronitrile) were added. The medium was degassed by bubbling with nitrogen for 1 hour. The reaction medium was subsequently placed in a thermostatically regulated bath at 65° C., under a stream of nitrogen, for 5 hours and at 75° C. for 8 hours.

At the end of the reaction, the polymer P1 was obtained with a degree of conversion determined by NMR of 75%.

### Example 2

### Preparation of a Polymer P2 of Poly(LA-Co-AA) Type by Inverse Micellar Radical Polymerization

### Preparation of a Micellar Solution S2

10 ml of Exxsol, 1 g of acrylic acid and 1 g of surfactant Mackamide WS1 were introduced into a glass flask. The mixture was stirred using a magnetic stirrer bar for 30 minutes, until a visually clear mixture was obtained.

### Inverse Micellar Polymerization

18.1 g of lauryl acrylate and 25.3 g of Exxsol D100 were introduced into a round-bottomed flask containing a magnetic stirrer. The solution obtained was purged under nitrogen for 30 minutes, after which 0.0512 g of Rhodixan A1, 7.6 g of the previously prepared micellar solution S2, and 0.082 g of 2,2′-azobis(2,4-dimethylvaleronitrile) were added. The medium was degassed by bubbling with nitrogen for 1 hour. The reaction medium was subsequently placed in a thermostatically regulated bath at 65° C., under a stream of nitrogen, for 5 hours and at 75° C. for 8 hours.

At the end of the reaction, the polymer P2 was obtained with a degree of conversion determined by NMR of 88%.

### Example 3 (Comparative Example)

### Preparation of a Polymer P3

In this example, polymerization was carried out without employing a micellar solution.

A mixture M of acrylic acid AA and of Exxsol 100 was used instead, to perform a synthesis similar to that of examples 1 and 2, as follows: 1 g of acrylic acid was introduced, without surfactant, into a glass flask containing 10 ml of Exxsol 1 g. The mixture was stirred using a magnetic stirrer bar for 30 minutes, by means of which a cloudy mixture was obtained.

Polymerization was performed as follows: 18.3 g of lauryl acrylate and 25.2 g of Exxsol D100 were introduced into a round-bottomed flask containing a magnetic stirrer. The solution obtained was purged under nitrogen for 30 minutes, after which 0.064 g of Rhodixan A1, 7.6 g of the previously prepared cloudy mixture M, and 0.08 g of 2,2′-azobis(2,4-dimethylvaleronitrile) were added. The medium was degassed by bubbling with nitrogen for 1 hour. The reaction medium was subsequently placed in a thermostatically regulated bath at 65° C., under a stream of nitrogen, for 5 hours and at 75° C. for 8 hours.

At the end of the reaction, the polymer P3 was obtained with a degree of conversion determined by NMR of 91%.

### Example 4

### Use of the Polymers of Examples 1 to 3 in an Inverse Emulsion

Polymers P1 and P2 (according to the invention) and polymer P3 (comparative), which were synthesized in the preceding examples, were tested as stabilizers for inverse emulsions under the following conditions.

Inverse emulsions were prepared at ambient temperature (25° C.), comprising, by weight relative to the total weight of the mixture:
28% of an oil (Exxsol D100)
70% of an aqueous 2M solution of NaCl
1.7% of Span 80
0.3% of one of the polymers tested.

Each of the emulsions was prepared according to the same protocol, varying only the polymer tested, namely:
dissolution of the Span 80 and of the polymer in the oil at ambient temperature (25° C.) with stirring for one minute;
addition of the aqueous 2M solution of NaCl (brine)
emulsification under Ultra Turrax at 13 500 rpm for 5 minutes.

Each of the emulsions obtained was divided into several samples:
100 microliters of the emulsion were diluted in 1900 microliters of Exxsol D100 for microscopy studies showing the appearance or non-appearance of agglomerates.
45 ml of the emulsion were used to initially measure the “oil split ratio” of the volume of oil separated from the emulsion to the total volume of the emulsion; in practice, this is measured by the ratio of the height of the separated oil to the total height of liquid in a tube of constant section. This ratio was measured at the start, after centrifugation (“oil split ratio t=0”).
one portion of the emulsion was stored in a first glass tube 15 cm tall (the emulsion was added to a height of 13 cm), and was used to study the stability of the emulsion at ambient temperature
a second portion, stored in a second, identical, glass tube, was employed to study the stability of the emulsion at 50° C.
after one month, 45 ml from each of the storage tubes was used to measure, after storage and respectively at ambient temperature and at 50° C., the amount of oil separated from the emulsion (“oil split ratio t=1m 25° C.” and “oil split ratio t=1m 50° C.”) without centrifugation.

The results obtained are reported in the table below:

| | | oil split ratio | | |
|---|---|---|---|---|
| Polymer | Presence | t = 0 | t = 1 m | t = 1 m |
| tested | of aggregates | after centrifugation ⁽¹⁾ | 25° C. | 50° C. |
| P1 | No | 12% (4500 rpm) | 1.2% | 3.1% |
| P2 | Few | 13% (4500 rpm) | 1.5% | 3.1% |
| P3 | Very strong: sample | 8% (2400 rpm) | 1.2% | Phase |
| | filled with aggregates | | | separation |

⁽¹⁾ Note: The values of 12 and 13% measured with polymers P1 and P2 after centrifugation at 4500 rpm correspond to values which would be approximately 3 to 4% with centrifugation at 2400 rpm, i.e. much lower than with the comparative polymer P3.

1. A process for preparing a block copolymer, which comprises a step (E) of radical polymerization in which the following are brought into contact, in an oily medium (M):
monomers m1 dissolved in said oily medium (M);
monomers m2, which are insoluble in the medium (M) and which are present in the form of a micellar solution, i.e. contained in micelles dispersed in the medium (M);
at least one radical polymerization initiator, which is soluble or dispersible in the medium (M); and
a radical polymerization control agent.

2. The process as claimed in claim 1, using a radical polymerization control agent which is a compound which comprises a thiocarbonylthio —S(C═S)— group.

3. The process as claimed in claim 1, wherein the medium (M) is cyclohexane or a liquid paraffin.

4. The process as claimed in claim 1, wherein the monomers m1 are selected from the group consisting of tert-butyl acrylate, isobornyl (meth)acrylate, 2-ethylhexyl acrylate, lauryl acrylate (LA), lauryl methacrylate (LMA), stearyl acrylate (SA), stearyl methacrylate (SMA), behenyl (meth)acrylate, oleyl (meth)acrylate and mixtures thereof.

5. The process as claimed in claim 1, wherein the monomers m2 are selected from the group consisting of acrylic acid (AA), hydroxyethyl methacrylate (HEMA), N,N-dimethylacrylamide (DMA) and mixtures thereof.

6. The process as claimed in claim 1, wherein the monomers m2 are employed in a micellar solution comprising surfactants having a hydrophilic-lipophilic balance (HLB) of less than 9.

7. The process as claimed in claim 6, wherein the weight ratio of the total weight of surfactants present in the medium (M) of step (E) to the weight of monomers m2 initially present in the medium (M) of step (E) is greater than or equal to 0.6:1.

8. A polymer which is obtained according to the process of claim 1.

9. A method, comprising modifying an oily medium or an interface between an oily medium and another medium with a polymer as claimed in claim 8.

10. A water-in-oil emulsion or a dispersion of hydrophilic particles in an oily medium, comprising at least one polymer as claimed in claim 8.

11. The process as claimed in claim 2, wherein the thiocarbonylthio —S(C═S)— group is a xanthate.

12. The process as claimed in claim 7, wherein the weight ratio of the total weight of surfactants present in the medium (M) of step (E) to the weight of monomers m2 initially present in the medium (M) of step (E) is between 0.6:1 and 5:1.

13. The method of claim 11, wherein the modifying an oily medium or an interface between an oily medium and another medium comprises forming and/or stabilizing an inverse emulsion or another dispersed system, the inverse emulsion or another dispersed system comprising:
droplets of water or of a hydrophilic liquid dispersed in an oily medium; or
hydrophilic particles dispersed in an oily medium.
